(19) United States
(12) Patent Application Publication
(10) Pub. No.: US 2008/0043404 A1
(43) Pub. Date: Feb. 21, 2008

(54) ELECTRONIC DEVICE USAGE CONTROLLER

(76) Inventor: Bruce Frankel, Northbrook, IL (US)

Correspondence Address: SUN MICROSYSTEMS;C/O SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/464,588

(22) Filed: Aug. 15, 2006

(51) Int. Cl. H02B 1/00

(52) U.S. Cl. 361/600

(57) ABSTRACT

An apparatus, which controls electronic device usage, includes a receiving device that has a terminal that is incompatible with standard electrical plugs and outlets and a standard electrical plug electrically coupled to the first connecting portion. An adapter unit has a first portion and a second portion. The first portion is equally compatible with the terminal of receiving device such that the first portion can be coupled to the terminal. The second portion is equally compatible with a standard electrical plug such that the second portion can be coupled to the standard electrical plug. An adaptor locking trap is configured to securely house at least the second portion of the adaptor unit and at least a portion of the standard electrical plug that can couple to the second portion of the adaptor unit therein.

### FIELD OF THE INVENTION

The present invention relates generally to an electronic control device and, more particularly, to a method and apparatus that controls the usage of electronic devices.

### BACKGROUND OF THE INVENTION

Monitoring, managing, and controlling a child's use of electrical appliances and/or devices remains a challenge in today's increasingly electronically dependent society. Television viewing unquestionably influences child socialization, maturation, and education and while it can be a powerful teaching aid, it can be equally a destructive degenerative force. While the influence of television programming continues to play a significant role in child development, the advent of other electronic devices raises familiar issues of control and supervision. Today's evolution of television-based games, play stations, and interactive entertainment presents parents with significant challenges for ensuring a balanced educational experience. It is often desirable to restrict a child's access to certain electronic appliances and/or devices. Parents may find it desirable to limit their children's exposure to television programming or interactive gaming programs, and to prevent contact to other types of electronic gadgets entirely.

Prior attempts to address the desire to control access to electronic devices have yielded limited success. Previous solutions include indiscriminately disrupting electrical power to a device, blocking the reception of certain television channels, and controlling appliance use by measuring the amount of electrical current being drawn. The conventional solutions are deficient in their ability to control usage in the current electronic environment.

There has been, therefore, a clear need for an effective way to monitor and control the use of electronic devices. What has been desired are methods and systems to detect and control electronic device usage.

### SUMMARY OF THE INVENTION

Methods and systems consistent with the present invention control electronic device usage. An embodiment of an inventive apparatus comprises a control unit coupled to a source of electrical power. The control unit is effective to manage electrical power access for at least one account through an outlet terminal, which is configured to be incompatible with standard electrical plugs. The apparatus further comprises an adapter unit having a first portion and a second portion, the first portion being equally compatible with the outlet terminal such that the first portion can be coupled to the outlet terminal, the second portion being equally compatible with a standard electrical plug such that the second portion can be coupled to the standard electrical plug. An adaptor locking trap is configured to securely house at least the second portion of the adaptor unit and at least a portion of the standard electrical plug that can couple to the second portion of the adaptor unit therein.

In accordance with methods consistent with the present invention, a method for controlling electronic device usage using a power control device is provided. The method comprises the steps of: configuring a control unit to manage electrical power access for at least one account through an outlet terminal, wherein the outlet terminal is configured to be incompatible with standard electrical plugs; coupling an adapter unit to the control unit at the at least one outlet terminal, the at least one adapter unit having a first portion and a second portion, wherein the first portion of each of the at least one adapter unit is configured to be equally compatible with each of the at least one outlet terminals, and wherein the second portion of the adapter unit is configured to be compatible with a standard electrical device plug; and securing a connection between the second portion of the adapter unit and standard electrical device plugs in an adapter locking trap.

In an embodiment, an apparatus for controlling electronic device usage is provided. The adapter unit has a first portion and a second portion. The first portion is equally compatible with an outlet terminal of an electronic device such that the first portion can be coupled to the outlet terminal. The outlet terminal is configured to be incompatible with standard electrical plugs and outlets. The second portion is equally compatible with a standard electrical plug such that the second portion can be coupled to the standard electrical plug. An adaptor locking trap is configured to securely house at least the second portion of the adaptor unit and at least a portion of the standard electrical plug that can couple to the second portion of the adaptor unit therein.

In an embodiment, an apparatus for controlling electronic device usage comprises a receiving device having a terminal that is incompatible with standard electrical plugs and outlets and a standard electrical plug electrically coupled to the first connecting portion. An adapter unit has a first portion and a second portion. The first portion is equally compatible with the terminal of receiving device such that the first portion can be coupled to the terminal. The second portion is equally compatible with a standard electrical plug such that the second portion can be coupled to the standard electrical plug. An adaptor locking trap is configured to securely house at least the second portion of the adaptor unit and at least a portion of the standard electrical plug that can couple to the second portion of the adaptor unit therein.

The features and advantages described in this disclosure and in the following detailed description are not all-inclusive, and particularly, many additional features and advantages will be apparent to one of ordinary skill in the relevant art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE DRAWINGS

These and other more detailed features of the present invention are more fully disclosed in the following specification, reference being to the accompany drawings, in which:

FIG. 1 is a high-level block diagram of an apparatus for controlling electronic device usage in accordance with methods and systems consistent with the present invention;

FIG. 2 is a depiction of an open adapter locking trap according to one embodiment of the present invention;

FIG. 3a depicts the side view of a closed adapter locking trap according to one embodiment of the present invention;

FIG. 3b is a front view of a closed adapter locking trap according to one embodiment of the present invention;

FIG. 3c is a rear view of a closed adapter locking trap according to one embodiment of the present invention.

FIG. 4A is a side view of an outlet terminal according to one embodiment of the present invention;

FIG. 4B is a front view of an outlet terminal according to one embodiment of the present invention;

FIG. 5A is a side view of a second adaptor according to one embodiment of the present invention;

FIG. 5B is a front view of a second adaptor according to one embodiment of the present invention; and

FIG. 6 is a flow diagram of illustrative steps for controlling electronic device usage using an electronic device manager in accordance with a method consistent with the present invention.

The Figures depict embodiments consistent with the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF THE PREFERRED EMBODIMENTS

The following description provides specific details for a thorough understanding of, and enabling description for, embodiments of the invention. However, one skilled in the art will understand that the invention may be practiced without these details. In other instances, well known structures and functions have not been shown or described in detail to avoid unnecessarily obscuring the description of the embodiments of the invention.

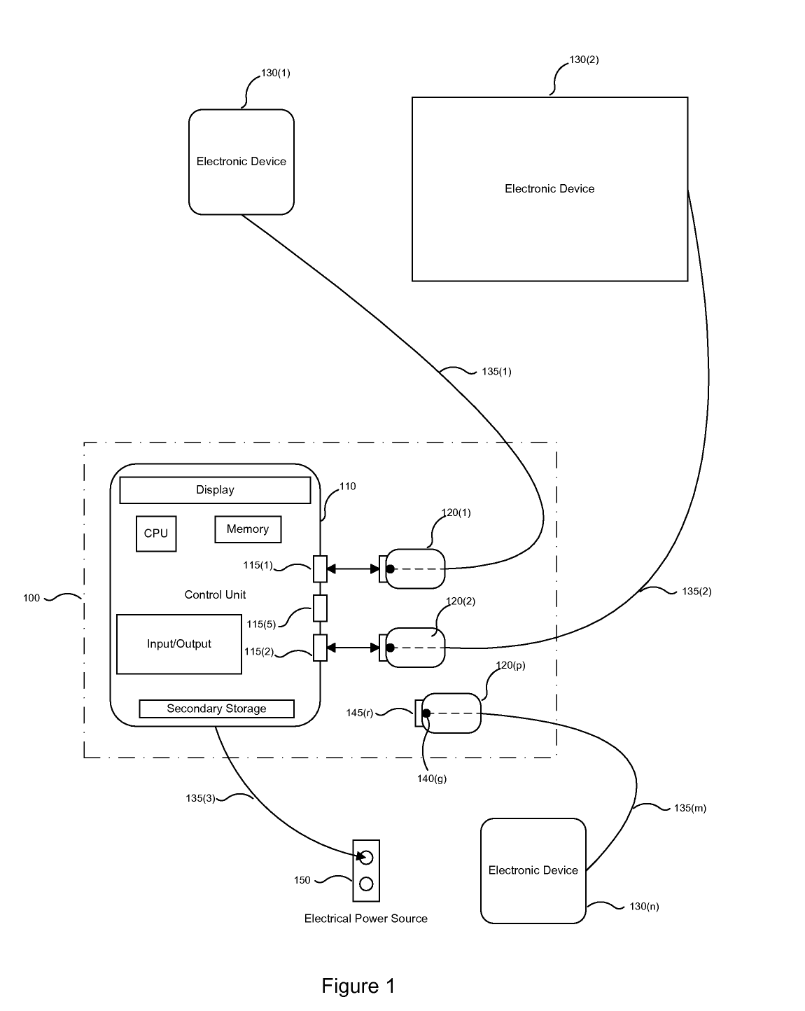

FIG. 1 illustrates a high-level block diagram of an apparatus for controlling electronic device usage consistent with the present invention. An electronic device manager 100 manages access to electrical power to at least one electronic device 130 based on predetermined time allotments for individual account holders. Once access is granted through verification of a proper access code, power is supplied to selected electronic devices 130. The duration of the access for that specific account is monitored by the electronic device manager 100. When the account reaches a prescribed elapsed time limit, electrical power is removed from the electronic device(s) 130, thereby controlling total use of electronic devices for the account holder.

It is to be understood that although the electronic device manager 100 is illustrated as a single entity, as the term is used herein an electronic device manager 100 refers to a collection of functionalities which can be implemented as software, hardware, firmware or any combination of these. Where the electronic device manager 100 is implemented as software, it can be implemented as a standalone program, but can also be implemented in other ways, for example as part of a larger program, as a plurality of separate programs, as one or more device drivers or as one or more statically or dynamically linked libraries. Where the electronic device manager is implemented as hardware, the device can comprise one or more elements that when used individually or in combination perform the functionalities described herein.

FIG. 1 is a high level block diagram of an apparatus for controlling electronic device usage according to some embodiments of the present invention. The electronic device manager 100 comprises, in one embodiment of the present invention, a control unit 110 and at least one detachable adapter locking trap 120. Each electronic device 130(1), 130(2) . . . 130(n) is connected to an adapter locking trap 120(1), 120(2) . . . 120(p) by an electric cord 135(1), 135(2), . . . 135(m). Each cord 135 possesses a standard electrical plug 140(1), 140(2) . . . 140(q), which connects to an adapter unit 145(1), 145(2), . . . 145(r) housed within the adapter locking trap 120. The adapter unit 145 transforms the standard electrical plug 140 connections into a unique plug design 260 configured to convey electrical power yet be incompatible with a standard electrical outlet or socket 150. For the purpose of the present invention a standard electrical plug and its corresponding socket is a plug/socket combination that conforms to American Standard NEMA 5-15, Canadian Standard CS22.2, British Standard BS 1363, and similar national standards established throughout the world.

Each adapter locking trap 120 is configured to couple with the control unit 110 through at least one outlet terminal 115(1), 115(2), . . . 115(s). Each outlet terminal 115 accepts the unique plug design 260 of the adapter unit 145. In one embodiment, the adapter unit 145 and outlet terminal 115 combination are universal, meaning that any adapter unit 145 consistent with the present invention is compatible with any outlet terminal 115 consistent with the present invention. In another embodiment, each adapter unit 145 and outlet terminal 115 combination is unique.

The adapter locking trap 120, which encases at least a portion of the electronic device's 130 standard electrical plug 140 and at least a portion of the adapter unit 145, is, in one embodiment, detachable from the control unit 110. While the number of outlet terminals 115 housed by the control unit 110 is finite based on the construction of the control unit 110, the number of adapter locking traps 120 capable of coupling electronic devices 130 to the control unit 110 is limited only by the number of adapter locking units 120 possessed by a user.

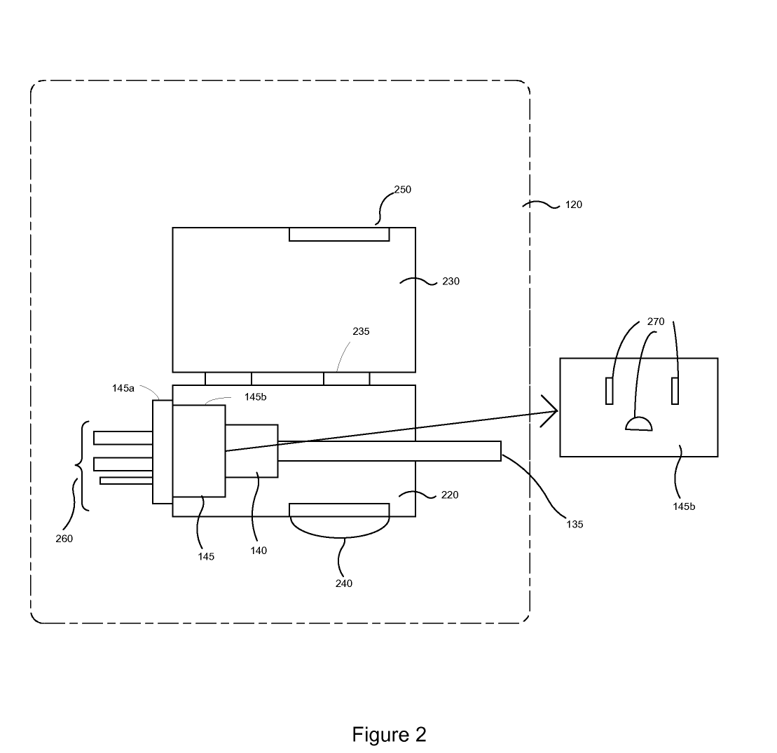

FIG. 2 depicts an open adapter locking trap 120 according to one embodiment of the present invention. The adapter locking trap 120 shown in FIG. 2 comprises a first half 220 and a second half 230 that are joined together by a hinge 235 or similar connector providing a two dimensional rotational coupling. An extendable locking mechanism 240 secured to the first half 220 of the adapter locking trap 120 is configured to extend and mate with a receiving locking mechanism 250 secured to the second half 230 of the adapter locking trap 120. Combined, the extendable locking mechanism 240 and the receiving locking mechanism 250 secure the first half 220 of the adapter locking trap 120 to the second half 230 of the adapter locking trap 120 to form a vessel.

In one embodiment, as shown in FIG. 2, an adapter unit 145 is mounted in a first end of the adapter locking trap 120 with a first portion 145a of the adapter unit 145 extending to the exterior of the vessel and a second portion 145b of the adapter unit 145 extending into the interior of the vessel. The first portion of the adapter unit 145 is configured with a unique plug design 260 for electrical power connection. The unique plug design 260 is configured to be compatible with one or more outlet terminals 115, such as those on the control unit 110, but incompatible with standard electrical outlets 150. The second portion of the adapter unit 145, which extends into the interior of the vessel, is configured to accept the standard electric plug 140. The standard electric plug 140 inserts into receptacles 270 of the second portion 145a of the adaptor unit 145. In the illustrative example, the electrical cord 135 attached to the electrical plug traverses the vessel and exits through the second end of the adapter locking trap 120 vessel opposite from the end housing the adapter unit 145. The electrical cord 135 exits the adapter locking trap 120 vessel through an opening sufficient to permit the cord 135 to pass but insufficient to allow the standard electric plug 140 to escape the adapter locking trap 120 vessel. The adapter locking trap 120 securely converts a standard electrical plug 140 to a unique plug design 260 compatible with the control unit 110.

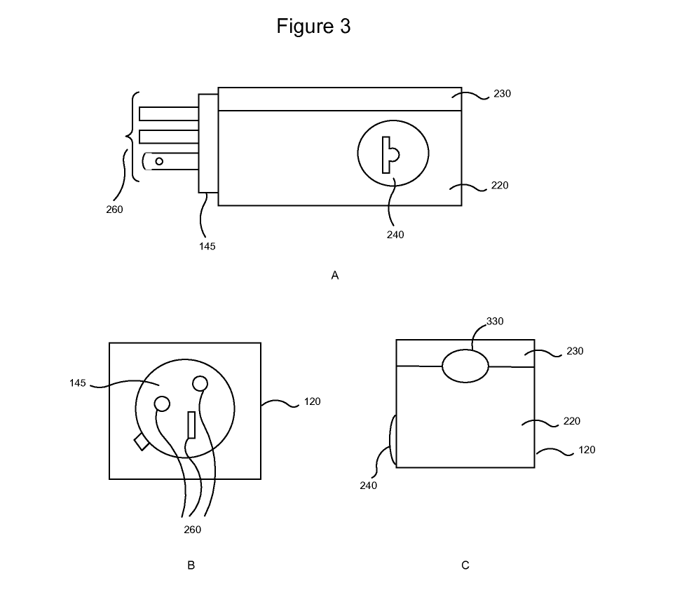

FIGS. 3a, 3b and 3c, respectively, are side and opposing end views of an illustrative closed adapter locking trap 120 according to one embodiment of the present invention. FIG. 3a is a side view of the adapter locking trap 120 and depicts the adapter unit 145 with its unique plug design 260 traversing an end of the adaptor locking trap 120. The locking mechanism 240 securing the first half 220 of the adapter locking trap 120 to the second half 230 of the adapter locking trap 120 is also depicted. FIG. 3b is a front view that depicts the illustrative unique plug design 260. The unique plug design is merely illustrative and alternative plug designs may be implemented. FIG. 3c is a rear view of the adapter locking trap 120, which view illustrates an opening 330 sufficient to allow the standard electric cord 135 to pass.

In the illustrative example, controlling usage of a electronic device may begin with securing the device's standard electrical plug 140 within the adapter locking trap 120. In one embodiment of the present invention, the adapter locking trap 120 is opened revealing the adapter unit 145. The standard electric plug 140 associated with an electronic device 130 is plugged into the adapter unit 145 so as to allow the attached electric cord 135 to traverse the adapter locking trap 120 and exit through the opening at the other end. Once the plug 140 is successfully mated with the adapter unit 145 the two halves of the adapter locking trap 120 are closed to form the vessel. The extendable locking mechanism 240 is extended to mate with the receiving locking mechanism 250 securing the connection. The locking mechanism may be a keyed lock, a combination lock or another engagement mechanism known to one skilled in the art to securely fasten the two halves of the adapter locking trap 120 together. Indeed, methods and systems consistent with the present invention contemplate any suitable means by which a standard electrical plug 140 can be securely converted to a unique plug design 260. In this embodiment, once the vessel is formed, the adapter locking trap 120 isolates an electronic device's 130 electrical plug 140 and converts it to the unique plug design 260 that is compatible with an outlet terminal 115 found on the control unit 110.

The adapter locking trap 120 connects to the control unit 110 at an outlet terminal 115. The unique plug design 260 associated with the adapter unit 145 is complemented by a similarly unique outlet terminal 115 design. While in combination, the two designs form a mutual connection and independently prevent other electronic devices 130, absent an adapter unit 145, from connecting to the control unit 110. Similarly, methods and systems consistent with the present invention prevent electronic devices 130 fitted with an adapter unit 145 and an adapter locking trap 120 from utilizing a standard electrical outlet 150 absent the control unit 110.

The three prong design of the unique plug design 260 shown in FIGS. 2 and 3 depicts one embodiment of the present invention. Other equally functional unique designs capable of connecting the adapter locking trap 120 to the control unit 110 while preventing the adapter locking trap 120 to be compatible with a standard electrical outlet 150 are contemplated in methods and systems consistent with the present invention.

Referring to FIG. 1, the control unit 110 includes a processing unit, a system memory, and a system bus that couples various system components including the system memory to the processing unit. The processing unit may be any logic processing unit, such as one or more central processing units (CPUs), digital signal processors (DSPs), application-specific integrated circuits (ASIC), etc. Unless described otherwise, the construction and operation of the various blocks shown in FIG. 1 are of conventional design. As a result, such blocks need not be described in further detail herein, as they will be readily understood by those skilled in the relevant art.

The control unit 110, in one embodiment of the present invention, also comprises a user input/output interface such as an alphanumeric keyboard, switches, or buttons, to convey access code information to the control unit 120. The control unit 110 can, in one embodiment of the invention, display time period management information to account holders via a display and/or a combination of visual indicators such as warning lights or audio indicators such as warning tones. As the electronic usage time depletes for an active account holder's account, the control unit 110 warns the account holder of imminent loss of electric power. As the allotted usage time is depleted, power is removed from the outlet terminals 115 resulting in loss of electrical power to the connected electronic devices 130.

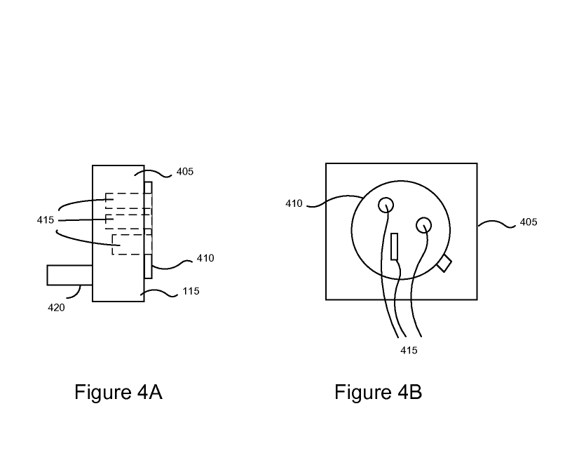

FIG. 4A depicts a side view of outlet terminal 115. Outlet terminal 115 has a receptacle portion 410 connected to a body portion 405. The receptacle portion 410 includes receptacle inlets 415 that may receive complementary plug leads. In the illustrative example, the receptacle inlets 415 receive the leads of the complementary unique plug design 260. The receptacle inlets 415 electrically couple that unique plug design 260 to the control unit 110 (or other associated electronic device) via wiring 420. FIG. 4B depicts a front view of the outlet terminal 115. As shown, the illustrative receptacle inlets 415 complement the unique plug design 260 of the illustrative adaptor locking trap 120.

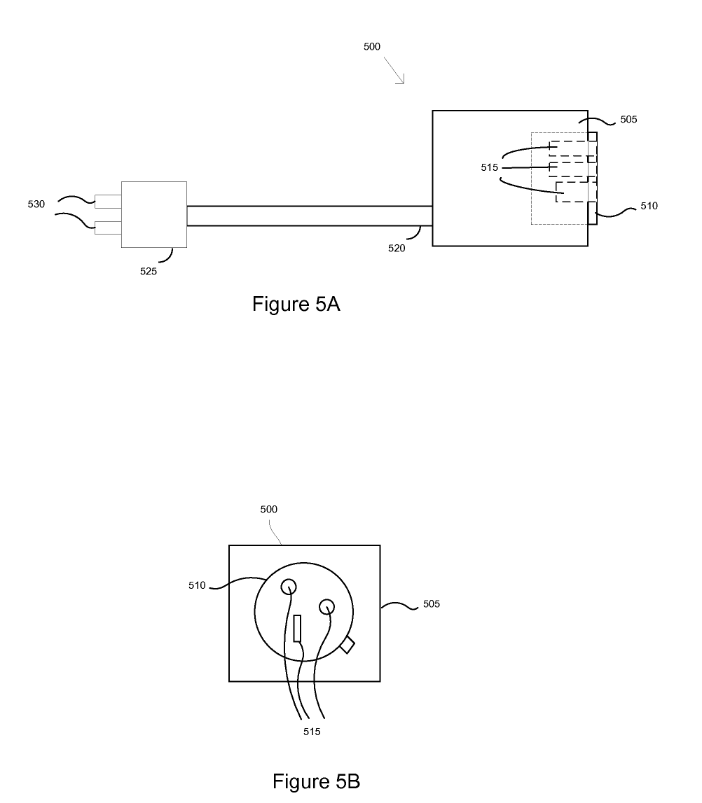

The unique plug design 260 of the adaptor locking trap 120 may alternatively plug into another adaptor, such as the second adaptor 500 shown in FIG. 5A. Second adaptor 500 includes a receptacle portion 510 connected to a body portion 505. The receptacle portion 510 includes receptacle inlets 515 that may receive complementary plug leads. In the illustrative example, the receptacle inlets 515 receive the leads of the complementary unique plug design 260. One having skill in the art will appreciate that the plug design of the receptacle inlets 415, 515, and the unique plug design 260 may be different than the illustrative examples. These plug designs are non-standard plug designs, which may be unique or proprietary. The receptacle inlets 515 are electrically coupled to an electrical power cord 520 and electrical plug 525. The electrical plug 525 includes standard plug terminal leads 530, which may be plugged into a standard power receptacle.

FIG. 5B depicts a front view of the second adaptor 500. As shown, the illustrative receptacle inlets 515 complement the unique plug design 260 of the illustrative adaptor locking trap 120.

Therefore, adaptor locking trap 120 may be used with control unit 110 or with another device that has receptacle adapted to receive the adaptor locking trap's unique plug design 260, such as second adaptor 500. In an illustrative example, adaptor locking trap 120 may be used with second adaptor 500 and without control unit 110. In this case, second adaptor 500 may be stored separately from adaptor locking trap 120 to prevent use of an electronic device 130, which has an electrical plug captured by adaptor locking trap 120. When a user wants to apply power to the electronic device 130, the user may retrieve second adaptor 500, plug the adaptor locking trap unique plug design 260 into the second adaptor's receptacle inlets 515, and plug the second adaptor's standard electrical plug 525 into a standard power receptacle via electrical connectors 530 having a standard configuration.

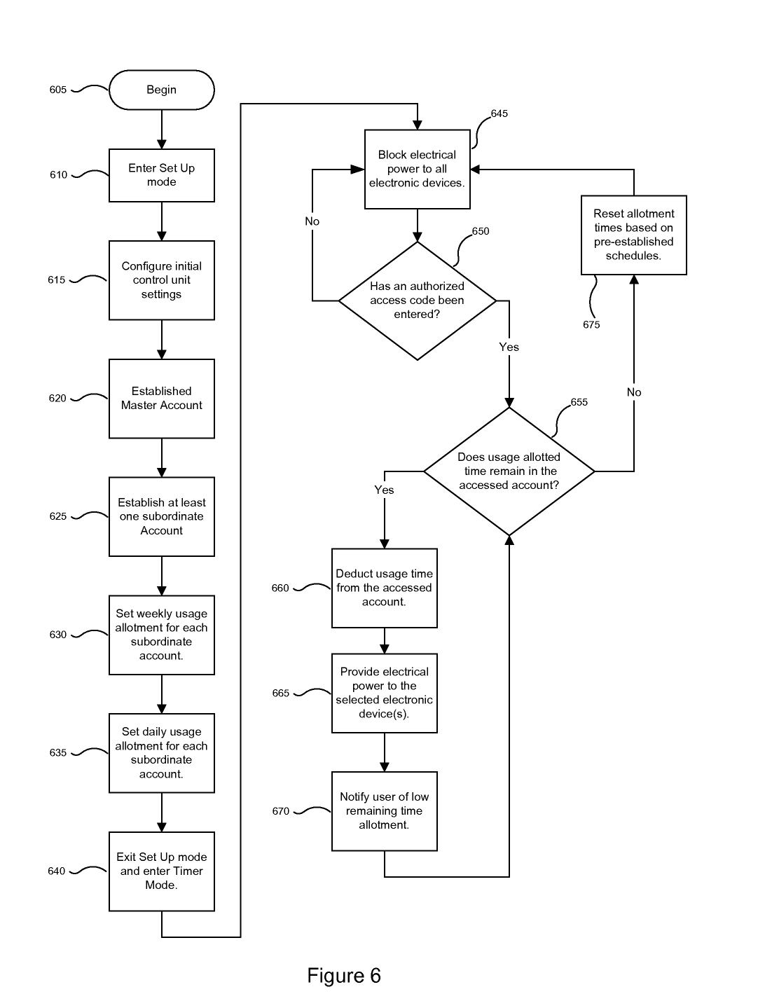

FIG. 6 is a flow diagram of illustrative method steps consistent with the present invention for controlling electronic device usage using a power control device. In the illustrative example, the method is effected in the data processing system having a program that is implemented in a programming language, such as Visual Basic, C++. or another programming language executable on the processor. The control unit 110 is initialized by entering an administrative or supervision code, causing the control unit 110 to enter set up mode 610. Once access has been granted, the control unit's 110 initial settings can be configured 615. A master account 620 and at least one subordinate account 620 is created to manage the usage time of connected electronic devices 130. In one embodiment of the present invention, the administrator sets 630 a weekly usage allotment for each subordinate account and sets 635 a daily usage allotment for each subordinate account. Once the accounts and the usage allotment are established, the administrator exits 640 set up mode and places the control unit 110 into timer mode

In timer mode, the control unit 110 defaults to block 645 electrical power to the connected electronic devices 130. Power is not supplied to any of the outlet terminals 115, preventing electronic devices connected to the control unit 110 to operate. To provide electric power to the device, a user inputs an access code into the control unit 110. The control unit 110 verifies 650 the authenticity of the code and determines 655 whether the accessed account has any allotted usage time remaining for the current time period. When a usage allotment remains, the electronic device manager 100 begins deducting 660 usage time from the account and provides electrical power 665 to the outlet terminals 115 of the control unit 110. The electronic device manager 100 monitors the usage and notifies 670 the user that allotted usage time during the current allotment period is running low. In one embodiment of the present invention, the control unit 110 warns the user of an impending loss of electrical power by providing visual warnings such as a blinking light and/or audio warnings, such as a beeping tone, that can vary in intensity and frequency. In another embodiment of the present invention, the user may initiate one or more 5 minute pauses during the usage session, for example. During the pause, the control unit 110 stops deducting time for the usage allotment. The number of pauses, total duration of the pauses, or any combination thereof during a single access event is set by the administrator. As long as usage time remains, power is supplied to the outlet terminals 115 and thus the connected electronic devices 130.

Upon the depletion of allotted usage time, the control unit 110 determines if the allotment times should be reset 675 based on a predetermined schedule. In one embodiment of the present invention, daily and weekly usage allotments are established by the administrator. For example, every 24 hours, the daily usage allotment can be reset, while a weekly usage total can be monitored and managed by the electronic device manager 100. For example, a parent may elect that a child can use electronic devices no more than 2 hours a day or 6 hours a week. The child would provide his or her access code to the control unit 110 to gain access to the connected electronic devices 130. The child would be limited to a usage time of 2 hours within any single 24 hour period or a total of 6 hours over a 7 day period. When the child uses less than his or her prescribed limit, the control unit stores the remaining time for use at a later date but not to exceed the weekly maximum. The allotment values can be modified by the administrator, who possesses a separate access code.

As will be understood by those familiar with the art, methods and systems consistent with the present invention may be embodied in other specific forms without departing from the spirit or essential characteristics thereof. Likewise, the particular naming and division of the modules, managers, functions, systems, engines, layers, features, attributes, methodologies and other aspects are not mandatory or significant, and the mechanisms that implement the invention or its features may have different names, divisions and/or formats. Furthermore, as will be apparent to one of ordinary skill in the relevant art, the modules, managers, functions, systems, engines, layers, features, attributes, methodologies and other aspects of the invention can be implemented as software, hardware, firmware or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment. Accordingly, the disclosure of the present invention is intended to be illustrative, but not limiting, of the scope of the invention, which is set forth in the following claims.

What is claimed is:

1. An apparatus for controlling electronic device usage, the apparatus comprising:
a control unit that may be coupled to a source of electrical power, the control unit effective to manage electrical power access for at least one account through an outlet terminal, the outlet terminal being configured to be incompatible with standard electrical plugs;
an adapter unit having a first portion and a second portion, the first portion being equally compatible with the outlet terminal such that the first portion can be coupled to the outlet terminal, the second portion being equally compatible with a standard electrical plug such that the second portion can be coupled to the standard electrical plug; and
an adaptor locking trap configured to securely house at least the second portion of the adaptor unit and at least a portion of the standard electrical plug that can couple to the second portion of the adaptor unit therein.

2. The apparatus of claim 1 wherein the control unit is configured to manage electrical power access for each of the at least one accounts based on elapsed usage over a predetermined period of time.

3. The apparatus of claim 1 wherein the control unit comprises a display device and a user input/output device.

4. The apparatus of claim 1 wherein the at least one account comprises a master account and at least one subordinate accounts, and wherein the master account is configured to control the electrical power access of the subordinate accounts.

5. The apparatus of claim 4 wherein access to the master account is password protected.

6. The apparatus of claim 1 wherein the adapter locking trap comprises:
a hinged housing having a first half and a second half, the first half and the second half forming a vessel when closed, the vessel having a first end and a second end, wherein the unit traverses the first end of the adapter locking trap, the first portion of the adapter unit extending to the exterior of the first end of the vessel, the second portion of the adapter unit extending to the interior of the vessel, the second end configured to form an opening sufficient to permit an electrical cord that is attached to the standard electrical plug to pass through the opening and effective to prevent the standard electrical plug from escaping the vessel;
an extendable locking mechanism secured to the first half of the hinged housing; and
a receiving portion secured to the second half of the hinged housing configured to receive the extendable locking mechanism when the first half and the second half of the hinged housing form the vessel, the receiving portion configured to fasten the extendable locking mechanism secured to the first half of the hinged housing to the second half of the hinged housing preventing unauthorized access to the secure couple between the second portion of the adapter unit and the standard electrical device plug.

7. A method for controlling electronic device usage using a power control device, the method comprising the steps of:
configuring a control unit to manage electrical power access for at least one account through an outlet terminal, wherein the outlet terminal is configured to be incompatible with standard electrical plugs;
coupling an adapter unit to the control unit at the at least one outlet terminal, the at least one adapter unit having a first portion and a second portion, wherein the first portion of each of the at least one adapter unit is configured to be equally compatible with each of the at least one outlet terminals, and wherein the second portion of the adapter unit is configured to be compatible with a standard electrical device plug; and
securing a connection between the second portion of the adapter unit and standard electrical device plugs in an adapter locking trap.

8. The method of claim 7 wherein the control unit is configured to manage electrical power access for each of the at least one accounts based on elapsed usage over a predetermined period of time.

9. The method of claim 7 wherein the control unit comprises a display device and a user input/output user interface.

10. The method of claim 7 wherein the at least one account comprises a master account and at least one subordinate accounts, and wherein the master account is configured to control the electrical power access of the subordinate accounts.

11. The method of claim 10 wherein access to the master account is password protected.

12. The method of claim 7 wherein securing comprises:
forming a vessel from a hinged housing, the hinged housing having a first half and a second half, the first half and the second half combining to form the vessel when closed, the vessel having a first end and a second end, wherein the adapter unit traverses the first end of the adapter locking trap, the first portion of the adapter unit extending to the exterior of the first end of the vessel and the second portion of the adapter unit extending to the interior of the first end of the vessel, the second end configured to form an opening sufficient to permit an electrical cord that is attached to the standard plug to pass through the opening and effective to prevent the standard electrical plug from escaping the vessel;
securing an extendable locking mechanism to the first half of the hinged housing;
securing a receiving portion to the second half of the hinged housing so as to receive the extendable locking mechanism when the first half and the second half of the hinged housing form the vessel, and
fastening the extendable locking mechanism of the first half of the hinged housing to the second half of the hinged housing preventing unauthorized access to the secure couple between the second portion of the adapter unit and the standard electrical device plug.

13. An apparatus for controlling electronic device usage comprising:
an adapter unit having a first portion and a second portion, the first portion being equally compatible with a terminal of a receiving device such that the first portion can be coupled to the terminal, the terminal being configured to be incompatible with standard electrical plugs and outlets, the second portion being equally compatible with a standard electrical plug such that the second portion can be coupled to the standard electrical plug; and
an adaptor locking trap configured to securely house at least the second portion of the adaptor unit and at least a portion of the standard electrical plug that can couple to the second portion of the adaptor unit therein.

14. The apparatus of claim 13 wherein the adapter locking trap comprises:
a hinged housing having a first half and a second half, the first half and the second half forming a vessel when closed, the vessel having a first end and a second end, wherein the unit traverses the first end of the adapter locking trap, the first portion of the adapter unit extending to the exterior of the first end of the vessel, the second portion of the adapter unit extending to the interior of the vessel, the second end configured to form a opening sufficient to permit an electrical cord that is attached to the standard electrical plug to pass through the opening and effective to prevent the standard electrical plug from escaping the vessel;
an extendable locking mechanism secured to the first half of the hinged housing; and
a receiving portion secured to the second half of the hinged housing configured to receive the extendable locking mechanism when the first half and the second half of the hinged housing form the vessel, the receiving portion configured to fasten the extendable locking mechanism secured to the first half of the hinged housing to the second half of the hinged housing preventing unauthorized access to the secure couple between the second portion of the adapter unit and the standard electrical device plug.

15. The apparatus of claim 13, wherein the receiving device is an apparatus for controlling electronic device usage.

16. The apparatus of claim 13, wherein the receiving device comprises:
a terminal that is equally compatible with the first portion of the adapter unit; and
a standard electrical plug electrically coupled to the first connecting portion.

17. An apparatus for controlling electronic device usage comprising:
a receiving device having a terminal that is incompatible with standard electrical plugs and outlets and a standard electrical plug electrically coupled to the first connecting portion; and
an adapter unit having a first portion and a second portion, the first portion being equally compatible with the terminal of receiving device such that the first portion can be coupled to the terminal, the second portion being equally compatible with a standard electrical plug such that the second portion can be coupled to the standard electrical plug;
an adaptor locking trap configured to securely house at least the second portion of the adaptor unit and at least a portion of the standard electrical plug that can couple to the second portion of the adaptor unit therein.
